(19) United States
(12) Patent Application Publication
(10) Pub. No.: US 2009/0180992 A1
(43) Pub. Date: Jul. 16, 2009

(54) COMPOSITIONS AND METHODS FOR THE TREATMENT, MITIGATION AND REMEDIATION OF BIOCORROSION

(75) Inventors: Neil S. Summer, Caldwell, TX (US); Elizabeth J. Summer, Caldwell, TX (US); Ryland F. Young, III, College Station, TX (US)

Correspondence Address: CHALKER FLORES, LLP, 2711 LBJ FRWY, Suite 1036, DALLAS, TX, 75234, US

(73) Assignee: THE TEXAS A&M UNIVERSITY SYSTEM, College Station, TX (US)

(21) Appl. No.: 12/334,271

(22) Filed: Dec. 12, 2008

Related U.S. Application Data
(60) Provisional application No. 61/013,141, filed on Dec. 12, 2007.
(60) Provisional application No. 61/102,825, filed on Oct. 4, 2008.

(51) Int. Cl. A01N 63/00; A01P 1/00

(52) U.S. Cl. 424/93.6

(57) ABSTRACT

A method of reducing biocorrosion or biofilm blockage in by identifying a target suspected of comprising one or more biocorrosive organisms and delivering to the target suspected of comprising the biocorrosive organisms an effective amount of a composition comprising an infective virulent viral panel sufficient to reduce the amount of biocorrosive organisms at the target.

### CROSS-REFERENCE TO RELATED APPLICATIONS

This case claims priority to U.S. Provisional Application Ser. No. 60/013,141, filed Dec. 12, 2007, and U.S. Provisional Application Ser. No. 61/102,825, filed Oct. 4, 2008, the entire contents of which are incorporated herein by reference.

### TECHNICAL FIELD OF THE INVENTION

The present invention relates in general to the field of methods and compositions to prevent corrosion, and more particularly, to compositions and methods for the treatment, mitigation and remediation of biocorrosion.

### STATEMENT OF FEDERALLY FUNDED RESEARCH

None.

### BACKGROUND OF THE INVENTION

Without limiting the scope of the invention, its background is described in connection with the remediation of corroded materials as a result of biological activity.

The oil and energy sectors confront the problems of corrosion, pipe necking (partial blockage) and scale buildup in pipes and pipelines on a frequent basis. One source of these problems is bacterial-mediated corrosion and bio-film blockages. Microbially influenced corrosion (MIC) negatively impacts the integrity, safety, and reliability of pipeline operations throughout the world. The responsible bacterial populations may be present in hydrocarbon and groundwater sources within the formation itself, in transmission pipelines, in refinery equipment and in storage and fuel tanks. Pipeline corrosion is a major issue and results in elevated costs, risks and a host of operating problems for the petroleum industry. Around 20-30% of this corrosion is related to microbial activity. Such microbiologically influenced corrosion (MIC) not only affects petroleum pipeline operations, but also microbial slime can lead to blockages and filter plugging. The responsible bacterial populations originate from hydrocarbon and groundwater sources within the subsurface, or are introduced into reservoirs during the water flood of secondary oil recovery. These bacteria cause problems from oil well production strings to transmission pipelines, and through refinery equipment, storage and even in end-user vehicle fuel tanks and fuel filters. Current technologies used to control microbial contamination include the use of chemical biocides and mechanical scraping of biofilms formed in pipelines with “pigs”. While huge amounts of biocide are pumped into petroleum pipelines, these chemicals have a recognized lack of efficacy against bacteria growing in biofilms. The biocides themselves are toxic to the environment and pose additional handling and disposal issues. Not surprisingly, bacterial biofilms rapidly redevelop after pigging, so the process must be repeated at frequent intervals. Clearly current methods are severely limited and there is a strong need for a new approach.

Chemical biocides are largely ineffectual against sessile bacteria protected in the complex communities known as biofilms, and it is exactly these chemically resistant biofilm communities that are the source of most biofouling and biocorrosion. Industry needs a perfect bactericide: cheap, safe to handle, natural, environmentally benign, and focused on the problem bacterial species sequestered in the biofilms. Currently no application of bacteriophage (phage) is used in the oil producing and refining industry although bioremediation in the form of “bacterially charged” bioreactors are currently used as part of environmental cleanup of fuel oil and other dense and light non-aqueous phase liquids spills.

Another problem encountered in the oil field is oil reservoir souring caused by injecting water with entrained indigenous viable sulfate reducing bacteria (SRBs) into the reservoir during reservoir stimulation activity, referred to as waterflooding. Water from any available source, which may be subsurface brines, formation water, produced water, fresh water from aquifers or seawater is injected into the formation to displace or push the oil towards the production well. Reservoir souring involves the formation of H₂S and incidental biofouling of the reservoir (coating of sand grains and fractures, destroying porosity and permeability). The bacterial-produced H₂S leads to major production difficulties, high risks and costs, to the point that producing wells are shut-in and abandoned.

Approaches to controlling bacterial populations that cause the aforementioned problems are varied. One method in the industry utilizes expensive steel alloys to resist biocorrosion. Another approach is to inject biocides such as sodium azide, Acrolein, QUATS, glutaraldehyde, benzyl alkonium chloride, and thiocyanate for example. Biocides, in particular, are long-lasting and considered toxic agents for the environment. Furthermore, biocides that U.S. industries use cost at least $1.3 billion per year, are toxic to humans and the environment, and face regulatory scrutiny and restrictions in the future.

Finally, a common approach to the biofilm buildup problem is to conduct pipeline cleaning using physical means (“pig runs”) to remove scale and biomass. Pipeline operators periodically ream pipelines physically with “pigs” that scrape bacteria and bacterial biofilms from the walls of the pipe [B. Y. Farquhar, G. B., Pickthall and DeCuir, J. A., “Solving Gulf Coast Oil Pipeline Bacteria related Corrosion Problem”, Pipeline and Gas Journal, March 2005].

New methods that complement (or obviate the need for) the established techniques for reducing biocorrosion, biofilm blockage and reservoir souring and/or serve as prophylactic measures would be beneficial to the petroleum industry.

### SUMMARY OF THE INVENTION

In one embodiment, the present invention includes compositions and methods of reducing biocorrosion or biofilm blockage by identifying a target suspected of having one or more biocorrosive organisms; and delivering to the target suspected of comprising the biocorrosive organisms an effective amount of a composition includes an infective virulent viral panel sufficient to reduce the amount of biocorrosive organisms. A virulent viral panel kills the bacterial host, other temperate viral panels are not appropriate for use in biocontrol. In one aspect, the target may include at least one of an oilfield structure, a pipeline, a storage tank and a subterranean formation. In another aspect, the method further includes the step of identifying at least a portion of the biocorrosive organisms and producing an infective virulent viral panel specific to infect the biocorrosive organism. In another aspect, the method may further include the step of monitoring changes in the population of biocorrosive organisms subsequent to delivering the infective viral panel.

The method of the present invention also includes the step of sampling the population of biocorrosive organisms after exposure to the infective viral panel and based on the results of the re-evaluation producing a modified infective viral panel in response to changes in the population of biocorrosive organisms and delivering the modified infective viral panel to the target.

In one aspect, the biocorrosive organisms targeted by the viral panel of the present invention are sulfate-reducing bacteria capable of sequestering iron. In another aspect, the biocorrosive organisms are sulfate-reducing comprises Desulfovibrionaceae selected from the group consisting of D. vulgaris, D. desulfuricans and D. postgatei. In yet another aspect, the biocorrosive organisms comprise Caulobacteriaceae selected from the group consisting of C. Gallionella and Siderophacus. A wide variety of organisms may be targeted by the viral panel, e.g., archaebacteria, eubacteria, fungi, slime molds and small organisms that are biocorrosive.

In another aspect, where the biocorrosive organisms cause biofilm blockage the method of the invention includes one or more of the following steps: screening for naturally occurring phages against the selected bacterial subpopulation or producing the infective viral panel, including creating engineered phages, against the selected biocorrosive organisms.

The phage (virus) of the present invention may be delivered in a wide variety of forms and by a variety of tools. In one aspect, the infective viral panel is delivered by injection into a subterranean oil or gas formation. In another aspect, the infective viral panel is delivered to a pipe using a pig. In another aspect, the infective viral panel is delivered via a medium that coats at least a portion of a contained system.

Another embodiment of the present invention is a composition having a concentrated infective viral panel in an amount and at a concentration sufficient to reduce the rate of biocorrosion at a target site. In one aspect, the infective viral panel is specific for sulfate-reducing bacteria capable of sequestering iron. In another aspect, the infective viral panel is specific for Desulfovibrionaceae selected from the group consisting of D. vulgaris, D. desulfuricans and D. postgatei. In yet another aspect, the infective viral panel is specific for Caulobacteriaceae selected from the group consisting of C. Gallionella and Siderophacus. In one specific aspect, the infective viral panel comprises bacteriophage.

In yet another embodiment, the present invention includes compositions and methods for reducing selected bacterial subpopulations in a hydrocarbon source comprising subjecting the hydrocarbon source to an infective viral panel.

Yet another embodiment of the present invention includes a phage-based bioremediation system comprising at least one infective phage wherein the phage reduces bacterial contamination within an oilfield transmission pipeline, petroleum refinery equipment, or a fuel storage tank. In one specific embodiment, the present invention includes a phage-based anti-corrosion system comprising an infective phage panel wherein the panel reduces sulfate-reducing bacterial populations capable of extracting iron.

In one aspect, embodiments of the present disclosure provide a method of reducing biocorrosion or biofilm blockage in a contained system that includes: (1) producing an infective phage panel against a selected bacterial subpopulation from a microbial population in the contained system; (2) delivering to the contained system the infective phage panel to reduce the selected bacterial subpopulation; where the contained system includes at least one oilfield structure such as a pipeline, a storage tank, and a subterranean formation. Optionally, the progress of the treatment can be monitored and the selected bacterial subpopulation re-evaluated. This allows for flexible treatment over extended periods of time.

In another aspect, the present disclosure provides a method of reducing reservoir souring that includes: (1) producing a first infective phage panel against a first selected bacterial population in a subterranean formation; (2) delivering to the subterranean formation the first infective phage panel to reduce the first selected bacterial population; (3) producing a second infective phage panel against a second selected bacterial population in a water supply used in waterflooding the subterranean formation; and (4) delivering to the water supply the second infective phage panel to reduce the second selected bacterial population. This two-prong approach covers likely sources of reservoir souring, the formation itself and the feed water used in waterflooding. The invention also includes each of the above described steps used alone.

In still another aspect, the present invention provides a method of reducing selected bacterial subpopulations in hydrocarbon sources that includes subjecting the hydrocarbon source to an infective phage panel. This may be valuable both in subterranean locations as well as storage tanks and refinery systems, for example.

Finally, a phage-based anti-corrosion system includes an infective phage panel wherein the phage panel affects the sulfate-reducing bacterial populations involved in the corrosion process. This could be applied to any type of container that might benefit from the protection against corrosive bacteria.

The foregoing has outlined the features of various embodiments in order that the detailed description that follows may be better understood. Additional features and advantages of various embodiments will be described hereinafter which form the subject of the claims of the invention.

### BRIEF DESCRIPTION OF THE FIGURES

For a more complete understanding of the features and advantages of the present invention, reference is now made to the detailed description of the invention along with the accompanying figures and in which:

FIG. 1 shows the effect of culturing Desulfovibrio vulgaris Hildenborough in the A. absence or B. presence of a phage-containing soil rinsate. The 50 ml screw cap tube to the left has 50 ml media and was inoculated with 500 ml of a rapidly growing culture of Desulfovibrio vulgaris Hildenborough. The tube to the right is identical except that a phage containing soil rinsate was also added. Both tubes were incubated anaerobically at 30° C. overnight.

FIG. 2 shows clearings formed by spotting 5 μl of undiluted E1 and E2 on a lawn of D. vulgaris.

FIG. 3 is an EM image of virulent myophage cultured on Desulfovibrio vulgaris ATCC 29579. Images are shown at the same magnification, bar=50 nm

### DETAILED DESCRIPTION

To facilitate the understanding of this invention, a number of terms are defined below. Terms defined herein have meanings as commonly understood by a person of ordinary skill in the areas relevant to the present invention.

### Definitions

As used herein, “target” or “contained system” refers to any material that may be corroded by the effect of organisms. Non-limiting examples of targets for corrosion by such organisms include any equipment susceptible to corrosion used under normal environmental conditions. The present invention will have particular applications in, e.g., the hydrocarbon production industry, such as, petroleum field related structures or equipment. Such equipment includes, for example, platforms, derricks, pipelines (such as transmission pipelines), refinery equipment ad systems, storage tanks and the like. Structures include subterranean formations, and the like.

As used herein, “biocorrosion” refers to processes in which any element of a contained system is structurally compromised due to the action of at least one member of a bacterial subpopulation. The exact mechanism by which biocorrosion is promoted is not known. It is generally thought, however, that there are several mechanisms that result in biocorrosion. For sulfate reducing bacteria (SRB), a taxonomically diverse group with the metabolic capacity of sulfate reduction, corrosion is associated with the production of hydrogen sulfide and sulfide mixtures that are corrosive to iron and iron alloys present in various components in the oil field, such as pipelines, storage tanks and the like. Some SRB species might also directly stimulate corrosion by scavenging the hydrogen film on water-exposed iron. The formation of hydrogen sulfide by these and related bacteria is also a significant cause of souring of petroleum components. One mechanism for corrosion may be bacterial sequestration of various metals that make up the inner (or outer) walls of the contained system, such as iron, for example. Another mechanism may be the generation of corrosive metabolites such as the “aggressive” chloride ion, for example [Videla, H. A. “Manual of Biocorrosion,” CRC Press, Boca Raton, Fla., 1996, page 5]. Still another mechanism of bacterial-mediated corrosion may be due to excretion of acidic metabolites, notably sulfuric acid. Ultimately, for the purposes of phage mitigation of biocorrosion, the exact mechanism by which the bacteria causes corrosion is not critical, only the information about which specific bacteria are causing corrosion in a specific system.

As used herein “biofilm blockage” refers to the buildup of micro-organism/bacteria and its associated biofilms within the cavity of pipes, for example, which causes reduced flow. Biofilm is a protective coating the bacteria utilize that can make biocide treatments difficult because of the need to penetrate the biofilm for effective reduction of the bacterial populations residing therein. A biofilm is typically a complex aggregation of microorganisms marked by the excretion of a protective and adhesive matrix. Biofilms are also often characterized by surface attachment, structural heterogeneity, genetic diversity, complex community interactions, and an extracellular matrix of polymeric substances.

As used herein, the terms “bacteriophage” “phage” or “viruses” includes those for which hosts may be any microbe, e.g., a prokaryote. Therefore, as used herein the term “virus”, “phage” or bacteriophage” is used interchangeably with various known terminologies for viruses of prokaryotes, e.g., phage, bacteriophage, prokaryotic viruses, procaryotic viruses, bacterial viruses, archaeaphage, archaeaviruses, Caudovirales, tailed phage, Myoviridae, Podoviridae, Siphoviridae unclassified Caudovirales, myophage, podophage, siphophage, mycophage, actinophage, cyanophage, Unicellular Organism Parasites, virioplankton, Viruses of Archaea, viruses of mesophilic and moderately thermophilic Eueryarchaeota, viruses of hyperthermophilic Crenarchaeota, crenarchaeal viruses, euryarchaeal viruses. Prokaryotes include organisms classified as either bacteria (eubacteria) or archaea (archaebacteria). Other terms used for these and their various subgroups include microorganisms, procaryotes, archaeobacteria, archaeobacteria, archaeon, archeon, true bacteria, Aquificae, Thermotogae, Thermodesulfobacteria, Nitrospira, Deferribacteres, Chloroflexi, Thermomicrobium, Fibrobacteres, Proteobacteria, Planctomycetes, Chlamydiae, Spirochaetes, Bacteroidetes, Chlorobi, Actinobacteria, Deinococcus-Thermus, Cyanobacteria, Firmicutes, Fusobacteria, Verrucomicrobia, Acidobacteria, Dictyoglomi, Eubacteria. Generally, viruses of prokaryotes, including members of the following categories of viruses: I: dsDNA viruses; II: ssDNA viruses; III: dsRNA viruses; IV: (+) ssRNA viruses; and V: (−) ssRNA viruses.

The virus-based bioremediation of this invention, in broad scope, includes at least one infective virus and/or phage wherein the virus reduces bacterial contamination within an oilfield production string, flowline, transmission pipeline, petroleum refinery equipment or system, a fuel storage tank or the like. The virus-based anti-corrosion system also includes an infective phage panel wherein the panel reduces selected bacterial populations capable of generating corrosive metabolites and/or developing a biofilm. The anti-corrosion system may be used in other locations subject to biofilm buildup and biocorrosion, for example in fuel tanks of refineries, in gas station tanks and the like. Phages are a natural, biodegradable and safe alternative to chemical biocides for controlling MIC and biofilms. Unlike other methods for treating biocorrosion in which lysogenic phage are induced by stressing bacteria using, e.g., a UV treatment (see, e.g., WO/2002/040642), the present invention makes use of virulent viruses, i.e., those that enter the lytic phase and kill their host bacteria without external stress or inducement to produce their activity. It has been found that such temperate phages (produced by lysogenic host bacteria) are not appropriate for use in biocontrol. The present invention requires no such induction because it takes advantage of virulent or lytic viruses to deliver, e.g., in a large bolus, an overwhelming amount of lytic virus to shift the balance against the microbial population causing biocorrosion in the local milieu. The lytic virus of the present invention can be delivered with a multiplicity of infection (MOI) from 1.0×10⁻⁵, 1.0×10⁻⁴, 0.001, 0.01, 0.1, 110, 10, 100, 1,000, 1.0×10⁴, 1.0×10⁵ to 1, virus to target microbe. Another manner in which to describe the dose is the lethal dose (LD₅₀), which would follow similar ratios of virus to target. The skilled artisan will recognize that sites of biocorrosion will often include natural or native lysogenic and perhaps even small amounts of lytic viruses. The present invention includes the delivery of an effective amount of lytic viruses sufficient to kill most or all the microbes causing biocorrosion. The term “biocorrosive microbes” is used to describe populations of bacterial, molds, fungi and even multi-cellular organisms that are biocorrosive or create biofilms on oil field equipment or related systems.

The present invention provides methods for reducing biocorrosion and biofilm blockage in contained systems within the petroleum field as well as reducing the incidence of oil and gas reservoir souring due to naturally occurring bacterial populations within the formation itself or populations introduced by waterflooding processes. In one embodiment, the present invention provides a method of reducing biocorrosion or biofilm blockage in a contained system through the application of lytic or virulent phage, that infect bacteria involved in the process of microbial influenced corrosion.

Methods for remediation of bacterial contamination of hydrocarbon sources are also provided. Such hydrocarbon sources include, for example, crude oil, refined fuels, and hydrocarbon stores in subterranean formations.

In one embodiment, a method for reducing biocorrosion or biofilm blockage in a contained system involves producing an infective phage panel against a selected bacterial subpopulation within the contained system and delivering to the contained system the infective phage panel to reduce the selected bacterial subpopulation. An effective panel is one that is considered as effective as biocide treatment. Currently, there is no single, standard test for effectiveness of biocide treatment in industrial settings analogous to those used for antibiotics and disinfectants. However, in many studies, treatments are considered positive when they result in a bacterial concentration drop of 4 orders of magnitude, for example, from 10⁷ to 10⁸ cfu/mL down to 10³ to 10⁴ cfu/mL. Success in reducing a bacterial population may also be measured by the abatement of pipe corrosion or pipe blockage without quantifying any remaining bacterial population.

Large Scale Virus Production of phage. It is necessary to be able to produce bacteriophage (phage) on a fairly large scale for commercial use of this invention. Phage is produced using a standard liquid lysate method. It should be noted that industrial scale virus production has been achieved inadvertently by the dairy industry and historically by the acetone/butanol fermentation industry which demonstrates the feasibility of aerobic and anaerobic virus production on this scale. 1. Prepare an exponentially (=OD600˜0.3) growing stock of the target host in the volume of liquid corresponding to the desired final lysate volume. This is done by inoculating the media from a stationary stage liquid culture to a very low (OD600˜0.01) and monitoring growth specrophotometrically until the desired OD is reached. 2. Inoculate this culture with virus to a moi (multiplicity of infection=ratio of virus particles to individual host cells) of 0.1 to 0.001. 3. The culture is then incubated until lysis is observed; typically over night but can take several days depending on the host growth rate. At this point the lysate is ready for purification of the virus particles away from both bacterial cell debris and the components of the culture media. This is accomplished first by vacuum filtration through a filter series with the final pore size being 0.2 μm. Finally, tangential flow filtration will be used to replace components of the media with 10 mM phosphate buffer and, if necessary, to concentrate the virus. The final product is an aqueous solution containing the virus particles in a weak phosphate buffer with minimal bacterial cellular debris.

Bacterial targets for viral remediation. The group of bacteria most commonly associated with MIC in petroleum pipelines are the sulfate-reducing bacteria (SRB). SRB reduce sulfates to sulfides, releasing sulfuric acid and hydrogen sulfide as byproducts that react with iron to form the characteristic black precipitate iron sulfide. Hydrogen sulfide gas is not only extremely toxic and flammable, but it causes souring of the petroleum product, resulting in reduced quality and increased handling cost. The term “SRB” is a phenotypic classification and several distinct lineages of bacteria are included under this umbrella term. Bacterial subpopulations involved in the microbial influenced biocorrosion process or the oilfield souring process include those that form the corrosive products and intermediate products of sulfate reduction, including, but not limited to, hydrogen sulfide. Such populations include those forming the taxonomically varied group known as the sulfate-reducing bacteria (SRB). Bacteria selected for virus treatment include members of the SRB including, including without limitation, are members of the delta subgroup of the Proteobacteria, including Desulfobacterales, Desulfovibrionales, and Syntrophobacterales. Regardless of taxonomic origin, the SRB develop in complex sessile assemblages along with other species, in biofilms attached to the inner wall of the pipeline, frequently in the “6 o'clock” position. The extracellular matrix of the biofilm is produced by the communal bacteria and is usually composed of sugar polymers commonly known as exopolysaccharides. Biofilm forming bacteria cause pipeline corrosion, production slowdown, product quality loss (souring), potential environmental hazards, and the well publicized leaks which are a detriment to company and industry image.

Bacteria selected for phage treatment also includes those that produce acidic metabolites. This specifically includes sulfur-oxidizing bacteria capable of generating sulfuric acid. These bacteria include, without limitation, sulfur bacteria such as Thiobacilli, including T. thiooxidans and T. denitrificans. Bacterial populations and isolates selected for phage treatment further includes corrosion associated iron-oxidizing bacteria. Also included are isolates of the Caulobacteriaceae including members of the genus Gallionella and Siderophacus.

Still further biocorrosive organisms, and populations thereof, may work synergistically with the aforementioned biocorrosive bacteria. These include members of microbial consortia exhibiting biofilm formation activity. Such biofilms provide the anaerobic microenvironment required for the growth of the corrosion promoting bacteria. As such, the target of phage treatment can include not just the corrosive metabolite producing bacteria but also any bacteria involved in forming the microenvironment required for corrosion. Additionally, biofilm producing bacteria involved in the biofouling process are included in the category of targets for phage abatement. Biofilm forming genera of bacteria include Pseudomonas or Vibrio species isolated in affected containment systems. All bacteria that are to be the targeted for phage treatment are part of the selected bacterial subpopulation.

Phage panels. Once identified, the next step in reducing the harmful effects of the selected bacterial subpopulation is to create a “cocktail” or panel of phages effective against the selected subpopulation. For this, phages exhibiting bacteriolytic activity against corrosion associated or causing bacteria will be selected. Bacteriophage (phage) are the ubiquitous, natural, water-borne predators of bacteria. Phages are highly abundant and diverse: each type attacks only specific bacterial hosts and are harmless to non-host bacteria, all other types of cells and especially to humans. In a typical infection cycle a single phage injects its DNA into a bacterial cell, starting a program that ends with the bursting of the host cell and the release of about 100 progeny virions.

Phage panels may include pre-existing phage isolates as well as the de novo isolation of novel phages from samples taken at industrial and environmental sites.

Thus, in one embodiment, the step of producing the infective phage panel further may include screening and isolating naturally occurring phages active against the selected bacterial population. In another embodiment, it may be unnecessary to screen for phages where the suspect bacterial populations are already known or suspected.

Identification of environmental sources of viruses active against bacterial strains involved in industrial contamination, fouling or corrosion. As the natural predators of bacteria, populations of bacterial viruses will be most abundant near abundant sources of their prey. Therefore, the logistics of identifying viruses specific for any bacterial population is to first identify an environmental site where that bacterial type is abundant. It is recognized herein that there is not one environment that will serve as a source of viruses for all target microbes. Instead, the exact environmental sample will vary from host strain to host strain. However, we have established general guidelines for identifying the environmental sample most likely to yield desired viruses. An ideal sample is a marine or freshwater sediment from an environment favorable for the growth of the host bacteria. Specific physiochemical properties of the sediments must be considered. While the exact parameters will vary from host to host, variables to consider include salinity, temperature, pH, nitrogen or eutrophication, oxygen, and specific organic compounds. An example, which is not intended to be a guideline for all protocols, would be the identification of virus active against a sulfate reducing bacterium (SRB) such as Desulfovibrio. Sediments enriched in SRB are characterized by a black anoxic layer and the production of odiferous volatiles such as hydrogen sulfide. These sediments are common in areas experiencing eutrophication in concert with the resulting oxygen depletion. Therefore, a sample likely to possess SRB specific viruses would be a black, hydrogen sulfide producing sediment collected from organic compound rich waters.

As an alternative to identifying samples based on physiochemical properties, molecular tools can be used to identify sediments possessing wild populations of bacteria similar to the target bacteria. These methods typically require some level of purification of DNA from the environmental sample followed by the detection of marker DNA sequences. The most straightforward of these are polymerase chain reaction (PCR) based technologies that target 16 s rDNA sequences. These can be analyzed by methods such as denaturing gradient gel electrophoreses (DGGE) or by DNA sequencing.

In another embodiment, it may be unnecessary to screen for phages where the suspect bacterial populations are already known or suspected.

Phages may be isolated by a number of methods including enrichment methods or any technique involving the concentration of phages from environmental or industrial samples followed by screening the concentrate for activity against specific host targets. Additionally, new methods for isolating phages are likely to be developed and any phages isolated by these methods are also covered by the claims. Given the high genetic diversity of phages, these naturally occurring phages will include those with novel genomic sequence as well as those with some percent of similarity to phages known to infect other bacterial clades. Most of these new phages are expected to be members of the taxonomic group Caudovirales, also generally referred to as the tailed phage. The use of phages in an infected cocktail is dependent on the phages bacteriolytic activity. Bacteria targeted by treatment with phage or phage panels includes any isolate present in the containment system

Phages can be optimized for effectiveness in the biocorrosion control purposes. Optimization of phages is accomplished by selection for naturally occurring variants, by mutagenesis and selection for desired traits, or by genetic engineering. Traits that might be optimized or altered include, but not limited to, traits involved in host range determination, growth characteristics, improving phage production, or improving traits important for the phage delivery processes. Thus, in another aspect, the step of producing the infective phage panel includes creating engineered phages against the selected bacterial population. This will include phages created for having a broad host range. This may be the product of directed genetic engineering, for example.

Collectively, the phages pooled together are referred to herein as the infective phage panel. Initial treatment with the infective phage panel is ideally followed up by monitoring of the contained system to reveal the effects on the selected bacterial subpopulation. Over longer periods of time it may be necessary to alter the phage panel to confront bacteria that have developed resistance mechanisms to the infective phage panel. Additionally, new bacterial species may begin to thrive in the absence of the initial selected bacterial subpopulation. Thus, the need may arise to alter the infective phage panel over time. New infective phage panels are created in response to either resistant strains or new bacterial populations causing biofilm blockages or biocorrosion. The effectiveness of the infective phage panel is monitored by evaluating changes in phage and bacterial host populations within the system. One can either determine the presence of such bacterial populations directly, or simply monitor the formation of new biofilms and the reoccurrence biocorrosion events.

Phage panel delivery. In some embodiments, the infective phage panel may be delivered into a target contained system by various means that will bring the phage into contact with the target bacteria. For example, the infective phage panel may be applied directly to the pipelines by using “pigs” that discharge a phage-impregnated liquid or gel, for example. For surface applications the infective phage panel can, for example, be injected into the sediments along an existing or planned pipeline route (as a prophylaxis) to inhibit biocorrosion.

The infective phage panel may also be delivered via a medium that coats at least a portion of any element of the contained system. For example, the infective phage panel may be incorporated into a paint or coating to “inoculate” the inside of a pipe or tank against further biocorrosion. Pipes may be spray coated with a phase solution when the pipe is being laid to prevent initial corrosion. The outside of a pipe, sieve, or tank can also be coated to mitigate biocorrosion.

The infective phage panel may be injected into an oil or gas reservoir in the subterranean formation to “inoculate” the target oil to lower selected naturally occurring bacterial populations in the subsurface oil reservoir. In offshore applications, the infective phage panel may be injected into the oil at the sub-sea manifold, at the riser, on the production platform, to inhibit the bacterial bloom and forestall or minimize biofilm formation and pipeline corrosion.

Additionally, the infective phage panel may be added to unrefined or processed fuel in storage facilities ranging from underground sequestration in strategic reservoirs, refinery tank farms, gas station tanks and ships, trains and vehicle tanks. A similar method may be performed to reduce selected bacterial populations in a hydrocarbon source by subjecting the hydrocarbon source to an infective phage panel.

Any method of getting the phage into contact with the area that bacteria are likely to grow (and therefore initiate biocorrosion or biofouling) is suitable and is not limited to those specifically enumerated above. Phage delivery is similar to biocide delivery since the phage are not generally mobile and must be delivered to the site of the target bacteria.

The present invention, in one embodiment, is a two pronged approach to reducing reservoir souring that includes (1) producing a first infective phage panel against a first selected bacterial population in a subterranean formation; (2) delivering to the subterranean formation the first infective phage panel to reduce the first selected bacterial population; (3) producing a second infective phage panel against a second selected bacterial population in a water supply used in waterflooding the subterranean formation; and (4) delivering to the water supply the second infective phage panel to reduce the second selected bacterial population. Reservoir souring is reduced with phage by inoculating the reservoir with phage against SRBs existing in the formation. Additionally an infective phage panel to counter selected bacterial populations existing in the seawater used in waterflooding can be used as a measure to prevent reservoir souring. This two-prong approach addresses bacterial populations from different sources that may be responsible for reservoir souring. The invention includes each of the above described prongs used individually.

### Example

This example illustrates the isolation of two novel contractile tailed phages capable of growth on the bacteria Desulfovibrio vulgaris Hildenborough.

Bacterial Culture: The host for the phage isolation study was the ATCC type strain, Desulfovibrio vulgaris subsp. vulgaris ATCC 29579. This strain is most commonly known as Desulfovibrio vulgaris Hildenborough and has been the subject of much corrosion based research. Genomic analysis of this strain has also been performed. Liquid cultures of D. vulgaris were grown in ATCC medium 1249 Modified Baar's medium for sulfate reducers. Plate cultures of D. vulgaris were grown on ATCC medium: 42 Desulfovibrio medium. Cultures were grown at either 22° C. or 30° C. in anaerobic GasPak jars (VWR). D vulgaris growth forms a characteristic black precipitate in media containing ferrous ammonium sulfate, an indicator of sulfate reduction.

Phage isolation: Phage isolation was performed using an enrichment procedure. Black mud samples were taken in the area around Freeport, Tex. Fifty (50) g of mud (wet) was mixed with 50 ml of ATCC medium 1249 in 50 ml screw cap tubes. Samples were shaken at room temperature over night. Chloroform was added to 0.1% v/v and the sample was shaken for an additional 30 minutes. Solids were pelleted by centrifugation (4,000 g, 20 minutes). The supernatant was filtered sequentially through 0.8 μm and 0.22 μm filters. Twenty five (25) mls of this bacteria-free rinsate was mixed with 25 ml of fresh media and inoculated with 500 μL of a logarithmically growing liquid culture of D. vulgaris Hildenborough. This was incubated overnight incubation at room temperature followed by the addition of 500 μl of chloroform, pelleting for 9,000 g for 10 min and sequential filtration through 0.8 μm and 0.22 μm filters, forming enrichment 1 (E1). Phages in E1 were amplified in a liquid lysate by inoculating 50 mls of fresh media, with 50 μl of E1, and 500 μl of the host. The culture was incubated overnight and phage were purified away from bacterial cells by chloroform treatment, centrifugation, and filtration using the same method that enrichment 1 was purified. This sample was called enrichment 2 (E2).

Phage Plating and EM Imaging: The presence of phage in E1 and E2 was determined using a spot assay. Agar plates were flooded with 500 μl of D. vulgaris Hildenborough and allowed to dry for 10 minutes. Excess liquid was removed by pipetting, then 5 μl of E1 and E2, along with a media control, was spotted onto the surface followed by anaerobic incubation.

Phages present in E2 were imaged by TEM by spotting onto 400 mesh carbon-coated copper grids and negatively stained with 2% (w/v) uranyl acetate. The samples were visualized with a JEOL 1200 EX at 25,000× mag, 100 kV, and scanned at 1270 DPI.

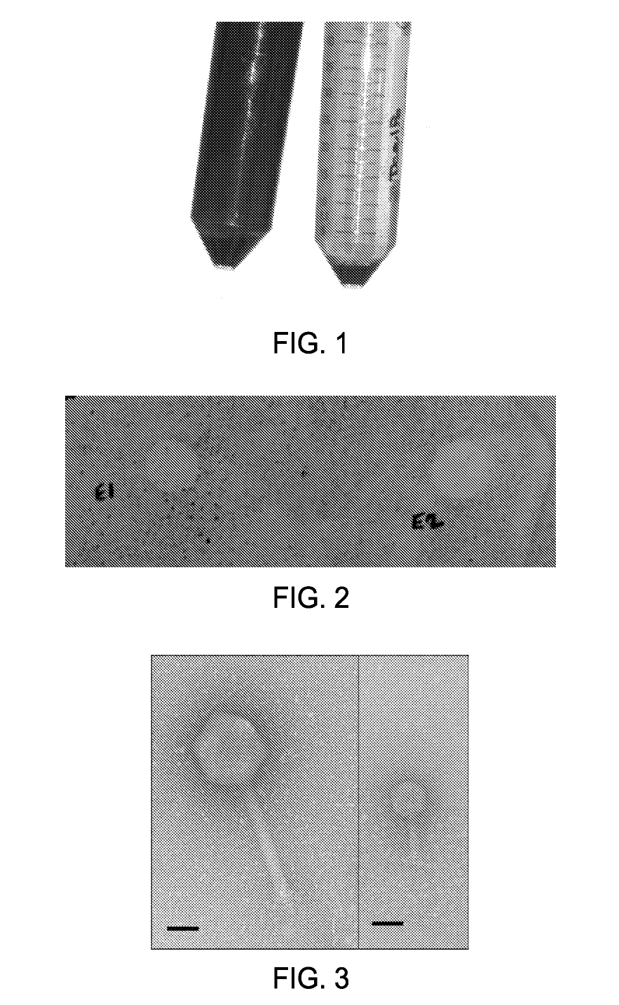

Phages of Desulfovibrio vulgaris Hildenborough were isolated from a Freeport, Tex. mud sample rinsates using a modification of a standard phage enrichment technique. Even prior to spotting or visualization by EM, the presence of phage in the Desulfovibrio enrichment was apparent due to the clearing of the culture and precipitation of iron sulfide (FIG. 1). In contrast, the parallel culture of Desulfovibrio not exposed to the rinsate remained viable and attached to the inside of the culture tube. The dark black growth of Desulfovibrio is characteristic of an SRB cultured in media containing ferrous ammonium sulfate.

A standard assay for phage activity is to spot the phage preparation onto lawns of bacteria and look for clear areas (plaques). When the 5 μl of E1 or E2 was spotted onto a spread plate lawn of D. vulgaris Hildenborough, clearing was observed (FIG. 2).

Electron microscopy imaging of E2 revealed the presence of at least two phage types (FIG. 3). One is a large, contractile tailed (myophage), with an isometric head size approximately 125 nm. This head size is characteristic of a phage possessing a genome greater than 150 kb. The other is a smaller myophage with a head size of approximately 60 nm. This is more characteristic of a phage possessing a genome less than 50 kb.

This example clearly illustrates the use of phage as a natural control agent for corrosion causing SRBs. The inventors have isolated, purified and identified sources of Desulfovibrio vulgaris Hildenborough phage and successfully performed enrichments and killing off the test bacteria. The straight-forward isolation of Desulfovibrio phage indicates that phages active against members of the SRB are abundant in some environments. This example summarizes the results from the isolation of two such novel phages (Dvib1 and Dvib2) capable of lytic growth on D. vibrio Hildenborough. Although very different in head diameter, both phages possess typical contractile myophage morphology. Dvib1 has a large non-prolate head, reminiscent of other large isometric myophage such as phiKZ and EL. Dvib2 is a smaller phage, similar in morphology to the Bcep781-like phages which are virulent myophages that plate on Burkholderia and Xanthomonas. Similar to most bacteria, the isolate of D. vulgaris used to propagate the phage is known to be a lysogen. There are at least three prophage present in the genome of D. vulgaris Hildenborough: two lambda like phages and two Mu like phages. Inductions with mitomycin C results in the production of a myophage (which the authors refer to as a “straight tailed phage”), likely to be one of the Mu-like phages, and a siphophage (which the authors refer to as a “bent tailed phage”), likely to be the Lambda like prophage. Both of these can form plaques on the D. vulgaris DePue strain but do not form plaques on Hildenborough. Neither Dvib1 or Dvib2 are similar in morphology to these phage. While Dvib2 is a small myophage, the tail to head ratio is clearly different from the previously described temperate phages as Dvib2 tail is shorter compared to the head size. Genomic analysis of Dvib1 and Dvib2 is required to know how these phages are related to other phages. However, given the immense genetic diversity of phage it is very likely that neither phage will be similar at a genomic level to phages currently in the public database.

All the necessary equipment and successful procedures to carry out the processes of this invention is available “off the shelf”.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing (and any form of containing, such as “contains” and “contain”) are inclusive or open-ended and do not exclude additional, un-recited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

Although specific embodiments have been disclosed herein in some detail, this has been done solely for the purposes of describing various features and aspects of embodiments, and is not intended to be limiting with respect to the scope of these embodiments. It is contemplated that various substitutions, alterations, and/or modifications, including but not limited to those implementation variations which may have been suggested herein, may be made to the disclosed embodiments without departing from the spirit and scope of the embodiments as defined by the appended claims which follow.

What is claimed is:

1. A method of reducing biocorrosion or biofilm blockage comprising:
identifying a target suspected of comprising one or more biocorrosive organisms; and
delivering to the target suspected of comprising the biocorrosive organisms an effective amount of a composition comprising an infective virulent viral panel sufficient to reduce the amount of biocorrosive organisms at the target.

2. The method of claim 1, wherein the target comprises at least one of an oilfield structure, vessel, a pipeline, a transfer line, a storage tank and a subterranean formation.

3. The method of claim 1, further comprising the step of identifying at least a portion of the biocorrosive organisms and producing an infective viral panel specific to infect the biocorrosisve organism.

4. The method of claim 1, further comprising the step of monitoring changes in the population of biocorrosive organisms subsequent to delivering the infective viral panel.

5. The method of claim 1, further comprising the step of sampling the population of biocorrosive organisms after exposure to the infective viral panel and based on the results of the re-evaluation producing a modified infective viral panel in response to changes in the population of biocorrosive organisms and delivering the modified infective viral panel to the target.

6. The method of claim 1, wherein the biocorrosive organisms comprises sulfate-reducing bacteria capable of sequestering iron.

7. The method of claim 1, wherein the biocorrosive organisms comprise sulfate-reducing comprises Desulfovibrionaceae selected from the group consisting of D. vulgaris, D. desulfuricans and D. postgatei.

8. The method of claim 1, wherein the biocorrosive organisms comprise Caulobacteriaceae selected from the group consisting of C. Gallionella and Siderophacus.

9. The method of claim 1, wherein the biocorrosive organisms causes biofilm blockage.

10. The method of claim 1, further comprising the step of screening for naturally occurring phages against the selected bacterial subpopulation.

11. The method of claim 1, wherein the step of producing the infective viral panel comprises creating engineered phages against the selected biocorrosive organisms.

12. The method of claim 1, wherein the infective viral panel is delivered by injection into a subterranean formation.

13. The method of claim 1, wherein the infective viral panel is delivered to a pipe using a pig.

14. The method of claim 1, wherein the infective viral panel is delivered via a medium that coats at least a portion of the contained system.

15. A composition comprising a concentrated infective viral panel in an amount and at a concentration sufficient to reduce the rate of biocorrosion at a target site.

16. The composition of claim 15, wherein the infective viral panel is specific for sulfate-reducing bacteria capable of sequestering iron.

17. The composition of claim 15, wherein the infective viral panel is specific for Desulfovibrionaceae selected from the group consisting of D. vulgaris, D. desulfuricans and D. postgatei.

18. The composition of claim 15, wherein the infective viral panel is specific for Caulobacteriaceae selected from the group consisting of C. Gallionella and Siderophacus.

19. The composition of claim 15, wherein the infective viral panel comprises bacteriophage.

20. A method of reducing reservoir souring by biocorrosive organisms comprising:
producing a first infective viral panel against a first selected biocorrosive organism population in a subterranean formation;
delivering to the subterranean formation the first infective viral panel to reduce the first selected biocorrosive organism population;
producing a second infective viral panel against a second selected biocorrosive organism population in a water supply used to waterflood the subterranean formation; and
delivering to the water supply the second infective viral panel to reduce the second selected biocorrosive organism population.

21. A method of reducing selected bacterial subpopulations in a hydrocarbon source comprising subjecting the hydrocarbon source to an infective viral panel.

22. A phage-based bioremediation system comprising at least one infective phage wherein the phage reduces bacterial contamination within an oilfield transmission pipeline, a petroleum refinery system, or a fuel storage tank.
